(19) United States
(12) Patent Application Publication
(10) Pub. No.: US 2005/0209931 A1
(43) Pub. Date: Sep. 22, 2005

(54) Comprehensive on line shopping & entertainment network

(76) Inventor: Jianfeng Jiang, San Jose, CA (US)

Correspondence Address: Jianfeng Jiang, 1149 El Prado Dr., San Jose, CA, 95120, US

(21) Appl. No.: 10/802,457

(22) Filed: Mar. 18, 2004

(51) Int. Cl. G06F 17/60

(52) U.S. Cl. 705/27

(57) ABSTRACT

A Comprehensive on line shopping & entertainment network combining interactive online gaming technology and web-camera technology is disclosed which consists of graphic images of sceneries with many stores. The sellers equipped with web-cameras can rent or buy the stores and display their goods or services. The buyers can browse through all the stores to buy the items they like, or they can also use search engine to locate the stores that sell the items they need. Within each store, the buyers can interact with the seller through text or audio instant-messaging interface to view the goods and negotiate the price. Live auctions can also be conducted using the instant messaging. On the other hand, interactive-on-line games can be developed using the same platform, which makes on-line shopping and gaming one entity.

### FIELD OF INVENTION

This invention relates to on-line shopping, on-line gaming, on line entertainment and e-commerce.

### BACKGROUND OF THE INVENTION

On-line shopping business has grown tremendously over the past several years. The famous web sites include Amazon.com, Ebay.com, Yahoo.com, and Expedia.com to name a few. However, all these on-line shopping sites use plain texts or still pictures to classify the goods into many categories. This is far cry from the feeling of shopping in the physical stores where the buyer can see the live images of the goods and interact with the seller directly. Especially with the expansion of goods categories, the traditional on-line shopping is becoming complicated and boring.

On the other hand, on-line gaming technology has also grown tremendously. The players can enjoy the vivid 3-D images, and interact with many other players on line.

The essence of the invention is to create an on-line shopping and entertainment network using web-cameras and on-line-gaming technology, so that on-line shopping will be more personal, visual, casual and entertaining.

### SUMMARY OF THE INVENTION

The invention starts out with an on-line gaming platform with beautifully generated sceneries, like a virtual city. The users can maneuver through the streets and go into stores.

Different from traditional on-line games, the stores on the streets are real businesses. The sellers rent or permanently buy out the store places. The sellers are required to equip with web-cameras, and provide a list of items they are selling, so that the buyers can both view the goods live, and do a text-based search to expedite the shopping.

Each store is an individual on-line community. Once a buyer enters a store, he will receive live web-broadcast of the goods. Also, he is automatically added to the community list. Each store has a list of goods for sale, as well as a list of how many people are in the store at the moment. There will be text or audio instant messaging interface for all the community members to communicate. The buyer can type in messages to ask seller to zoom in on a particular item, or negotiate sales price. Live auctions are also feasible through the interactive messaging interface. Once the buyer goes out of the store, he will be automatically removed from the community list of that store.

The stores can also be cinemas, theaters, concert hall or other live broadcast events, where the buyers can purchase tickets and go into the stores to enjoy live events. It should be pointed out that in order to really enjoy live broadcast, broadband communication network is essential. It may take several more years for broadband technology to be widely deployed.

It also needs to point out that when broadband communication technology is realized, the above mentioned web-cameras and live broadcasting can be made more enjoyable by using a set of lens with different focal lengths as shown in FIG. 1. In the example of FIG. 1, two kinds of lens are used, 1× magnification & 4× magnification. To make 4× magnification lens to cover the same area of 1× lens, Four 4× lens are combined with one 1× lens. With this lens combination, also with some yet-to-be-developed interface software, hardware zooming can be realized. ie. if the user want to zoom in on something, in reality, the images he viewed are changed from 1× lens to 4× lens. In this way, a large amount of users can freely zoom in & zoom out without actually moving the lens. Of course, to make this zoom effect more efficient, both software zoom & above mentioned hardware zoom should be utilized to achieve seemly smooth zooming.

Last thing to point out is that in order to save the network bandwidth, the users need to down load the 3-D modeling software onto their local PC, so that the virtual city images are rendered locally and only web-camera images are transferred through the Internet.

### DESCRIPTION OF THE DRAWINGS

FIG. 1 is one example of the combinational lens so that when the user switches from one lens to another, zooming effect can be achieved without actually moving the lens. This can be used in broadband live shows, where users can freely pan or zoom in on what they are interested.

1. A comprehensive on line shopping & entertainment network consisting of:
a: a graphics software downloadable into user's local computer to generate the images of the virtual city.
b: a number of virtual stores linked to real sellers equipped with web-cameras.
c: a platform for the user to browse through the virtual city and go in any stores
d: a platform for the user to view the live images of the store and communicate with the seller and other visitors of the store.

2. The “platform for the user to view the live images of the store and communicate with the seller and other visitors of the store” mentioned in item 1. refer to the idea that once the user enters a store, he is automatically added to the community of the store. He can then receive the live web-broadcast of the store, and communicate with seller and other visitors of the store via text or audio instant messaging interface.

3. The virtual city images can be periodically upgraded to keep users' shopping experience fresh and intriguing.

4. Many stores are rented to the same seller for only a limited length of time, so that the stores are constantly filled with different goods all around the world, which will also make the shopping experience fresh and exciting.

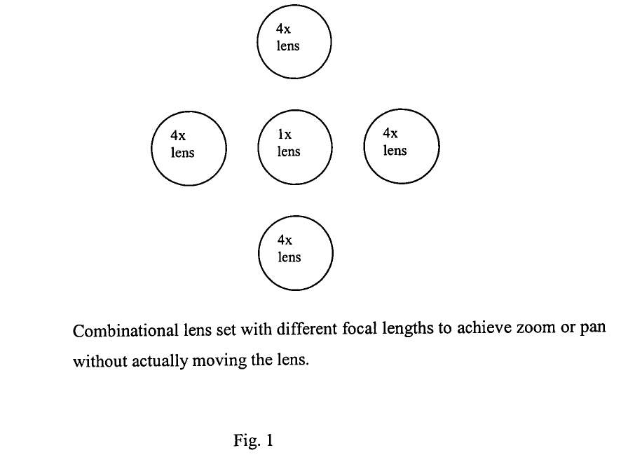

5. A combinational lens with different focal lengths, one example is shown in FIG. 1, the users can realize hardware zoom by switching from one lens to another without actually moving the lens.

6. Using a set of combinational lens mentioned in item 5. pointing to different directions, the hardware pan or zoom at any directions can be realized without actually moving the lens.

7. Combine the hardware pan or zoom mentioned in item 6. with traditional software zoom, a large amount of people can freely pan or zoom during live web-broadcast events without actually moving the lens.
